(19) United States
(12) Patent Application Publication
(10) Pub. No.: US 2019/0177537 A1
(43) Pub. Date: Jun. 13, 2019

(54) POLYAMIDE BLENDS FOR LASER SINTERED POWDER

(71) Applicant: BASF SE, Ludwigshafen am Rhein (DE)

(72) Inventors: Claus GABRIEL, Ludwigshafen am Rhein (DE); Florian RICHTER, Ludwigshafen am Rhein (DE); Philipp KLOKE, Schramberg (DE); Thomas MEIER, Ludwigshafen am Rhein (DE); Klaus STOLL, Ludwigshafen am Rhein (CH)

(21) Appl. No.: 16/321,086

(22) PCT Filed: Jul. 21, 2017
(86) PCT No.: PCT/EP2017/068526

§ 371 Date: Jan. 28, 2019

(30) Foreign Application Priority Data
Jul. 29, 2016 (EP) 16181976.8

(51) Int. Cl. C08L 77/02; B29C 64/153; B33Y 10/00; B33Y 70/00

(52) U.S. Cl. CPC C08L 77/02; B29C 64/153; B29K 2077/00; B33Y 70/00; C08L 2205/02; B33Y 10/00

(57) ABSTRACT

The present invention relates to a process for producing a shaped body by selective laser sintering of a sinter powder (SP). The sinter powder (SP) comprises at least one semicrystalline polyimide and at least one nylon-6I/6T. The present invention further relates to a shaped body obtainable by the process of the invention and to the use of nylon-6I/6T in a sinter powder (SP) for broadening the sintering window (W_{SP}) of the sinter powder (SP).

The present invention relates to a process for producing a shaped body by selective laser sintering of a sinter powder (SP). The sinter powder (SP) comprises at least one semicrystalline polyamide and at least one nylon-6I/6T. The present invention further relates to a shaped body obtainable by the process of the invention and to the use of nylon-6I/6T in a sinter powder (SP) for broadening the sintering window (W_{SP}) of the sinter powder (SP).

The rapid provision of prototypes is a problem which has frequently occurred in recent times. One process which is particularly suitable for this so-called “rapid prototyping” is selective laser sintering (SLS). This involves selectively exposing a polymer powder in a chamber to a laser beam. The powder melts, and the molten particles coalesce and solidify again. Repeated application of polymer powder and the subsequent exposure to a laser facilitates modeling of three-dimensional shaped bodies.

The process of selective laser sintering for production of shaped bodies from pulverulent polymers is described in detail in patent specifications U.S. Pat. No. 6,136,948 and WO 96/06881.

A factor of particular significance in selective laser sintering is the sintering window of the sinter powder. This should be as broad as possible in order to reduce warpage of components in the laser sintering operation. Moreover, the recyclability of the sinter powder is of particular significance. The prior art describes various sinter powders for use in selective laser sintering.

WO 2009/114715 describes a sinter powder for selective laser sintering that comprises at least 20% by weight of polyamide polymer. This polyamide polymer comprises a branched polyamide, the branched polyamide having been prepared proceeding from a pdlycarboxylic acid having three or more carboxylic acid groups.

WO 2011/124278 describes sinter powders comprising coprecipitates of PA 11 with PA 1010, of PA 11 with PA 1012, of PA 12 with PA 1012, of PA 12 with PA 1212 or of PA 12 with PA 1013.

EP 1 443 073 describes sinter powders for a selective laser sintering method. These sinter powders comprise a nylon-12, nylon-11, nylon-6,10, nylon-6,12, nylon-10,12, nylon-6 or nylon-6,6, and a free flow aid.

US 2015/0259530 describes a semicrystalline polymer and a secondary material which can be used in a sinter powder for selective laser sintering. Preference is given to using polyether ether ketone or polyether ketone ketone as semicrystalline polymer, and polyetherimide as secondary material.

US 2014/0141166 describes a polyamide blend which can be used as filament in a 3D printing process. This polyamide blend comprises, as semicrystalline polyamide, for example, nylon-6, nylon-6,6, nylon-6,9, nylon-6,10, nylon-7, nylon-11, nylon-12 or mixtures thereof and, as amorphous polyamide, preferably nylon-6/3T, where in the range from 30% to 70% by weight of the amorphous polyamide is present in the polyamide blend.

A disadvantage of the sinter powders described in the prior art for production of shaped bodies by selective laser sintering is that the sintering window of the sinter powder is frequently reduced in size compared to the sintering window of the pure polyamide or of the pure semicrystalline polymer. A reduction in the size of the sintering window is disadvantageous, since this results in frequent warpage of the shaped bodies during production by selective laser sintering. This warpage virtually rules out use or further processing of the shaped bodies. Even during the production of the shaped bodies, the warpage can be so severe that further layer application is impossible and therefore the production process has to be stopped.

It is thus an object of the present invention to provide a process for producing shaped bodies by selective laser sintering, which has the aforementioned disadvantages of the processes described in the prior art only to a lesser degree, if at all. The process shall be simple and inexpensive to perform.

This object is achieved by a process for producing a shaped body by selective laser sintering of a sinter powder (SP), wherein the sinter powder (SP) comprises the following components:
(A) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
(B) at least one nylon-6I/6T,
   wherein the sinter powder (SP) comprises in the range from 75% to 90% by weight of component (A) and in the range from 10% to 25% by weight of component (B), based in each case on the sum total of the percentages by weight of components (A) and (B).

The present invention further provides a process for producing a shaped body by selective laser sintering of a sinter powder (SP), wherein the sinter powder (SP) comprises the following components:
(A) at least one semicrystalline polyimide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6, 10
(B) at least one nylon-6I/6T.

It has been found that, surprisingly, the sinter powder (SP) used in the process of the invention has such a broadened sintering window (W_{SP}) that the shaped body produced by selective laser sintering of the sinter powder (SP) has distinctly reduced warpage, if any. In addition, the recyclability of the sinter powder (SP) used in the process of the invention is high even after thermal aging. This means that sinter powder (SP) not melted in the production of the shaped body can be reused. Even after several laser sinter cycles, the sinter powder (SP) has similarly advantageous sintering properties to those in the first sintering cycle.

The shaped bodies produced by the process of the invention additionally have smoother surfaces than the shaped bodies produced by processes described in the prior art and especially with sinter powders described in the prior art.

The process according to the invention is more particularly elucidated hereinbelow.

Selective Laser Sintering

The process of selective laser sintering is known per se to the person skilled in the art, for example from U.S. Pat. No. 6,136,948 and WO 96/06881.

In laser sintering a first layer of a sinterable powder is arranged in a powder bed and briefly locally exposed to a laser beam. Only the portion of the sinterable powder exposed to the laser beam is selectively melted (selective laser sintering). The molten sinterable powder coalesces and thus forms a homogeneous melt in the exposed region. The region subsequently cools down again and the homogeneous melt resolidifies. The powder bed is then lowered by the layer thickness of the first layer, and a second layer of the sinterable powder is applied and selectively exposed and melted with the laser. This firstly joins the upper second layer of the sinterable powder with the lower first layer; the particles of the sinterable powder within the second layer are also joined to one another by the melting. By repeating the lowering of the powder bed, the application of the sinterable powder and the melting of the sinterable powder, it is possible to produce three-dimensional shaped bodies. The selective exposure of certain locations to the laser beam makes it possible to produce shaped bodies also having cavities for example. No additional support material is necessary since the unmolten sinterable powder itself acts as a support material.

All powders known to those skilled in the art and meltable by exposure to a laser are suitable as sinterable powder in the selective laser sintering. According to the invention, the sinterable powder in the selective laser sintering is the sinter powder (SP),

In the context of the present invention, therefore, the terms “sinterable powder” and “sinter powder (SP)” can be used synonymously; in that case, they have the same meaning.

Suitable lasers for selective laser sintering are known to those skilled in the art and include for example fiber lasers, Nd:YAG lasers (neodymium-doped yttrium aluminum garnet laser) and carbon dioxide lasers.

Of particular importance in the selective laser sintering process is the melting range of the sinterable powder, called the “sintering window (W)”. When the sinterable powder is the sinter powder (SP) of the invention, the sintering window (W) is referred to in the context of the present invention as “sintering window (W_{SP})” of the sinter powder (SP). When the sinterable powder is component (A) present in the sinter powder (SP), the sintering window (W) is referred to in the context of the present invention as “sintering window (W_{A})” of component (A).

The sintering window (W) of a sinterable powder can be determined, for example, by differential scanning calorimetry, DSC.

In differential scanning calorimetry, the temperature of a sample, i.e. in the present case a sample of the sinterable powder, and the temperature of a reference are altered in a linear manner with time. For this purpose, heat is supplied to/removed from the sample and the reference. The amount of heat Q necessary to keep the sample at the same temperature as the reference is determined. The amount of heat Q_{R} supplied to/removed from the reference serves as a reference value.

If the sample undergoes an endothermic phase transformation, an additional amount of heat Q has to be supplied to keep the sample at the same temperature as the reference. If an exothermic phase transformation takes place, an amount of heat Q has to be removed to keep the sample at the same temperature as the reference. The measurement affords a DSC diagram in which the amount of heat Q supplied to/removed from the sample is plotted as a function of temperature T.

Measurement typically involves initially performing a heating run (H), i.e. the sample and the reference are heated in a linear manner. During the melting of the sample (solid/liquid phase transformation), an additional amount of heat Q has to be supplied to keep the sample at the same temperature as the reference. A peak is then observed in the DSC diagram, called the melting peak.

After the heating run (H), a cooling run (C) is typically measured. This involves cooling the sample and the reference in a linear manner, i.e. heat is removed from the sample and the reference. During the crystallization/solidification of the sample (liquid/solid phase transformation), a greater amount of heat Q has to be removed to keep the sample at the same temperature as the reference, since heat is liberated in the course of crystallization/solidification. In the DSC diagram of the cooling run (C), a peak, called the crystallization peak, is then observed in the opposite direction from the melting peak.

In the context of the present invention, the heating during the heating run is typically effected at a heating rate of 20 K/min. The cooling during the cooling run in the context of the present invention is typically effected at a cooling rate of 20 K/min.

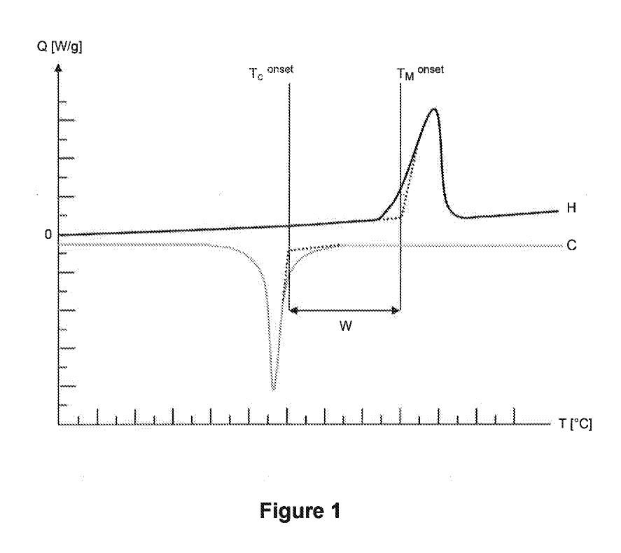

A DSC diagram comprising a heating run (H) and a cooling run (C) is depicted by way of example in FIG. 1. The DSC diagram can be used to determine the onset temperature of melting (T_{C}^{onset}) and the onset temperature of crystallization (T_{M}^{onset}).

To determine the onset temperature of melting (T_{M}^{onset}) a tangent is drawn against the baseline of the heating run (H) at the temperatures below the melting peak. A second tangent is drawn against the first point of inflection of the melting peak at temperatures below the temperature at the maximum of the melting peak. The two tangents are extrapolated until they intersect. The vertical extrapolation of the intersection to the temperature axis denotes the onset temperature of melting (T_{M}^{onset}).

To determine the onset temperature of crystallization (T_{C}^{onset}) a tangent is drawn against the baseline of the cooling run (C) at the temperatures above the crystallization peak. A second tangent is drawn against the point of inflection of the crystallization peak at temperatures above the temperature at the minimum of the crystallization peak. The two tangents are extrapolated until they intersect. The vertical extrapolation of the intersection to the temperature axis denotes the onset temperature of crystallization (T_{C}^{onset}).

The sintering window (W) results from the difference between the onset temperature of melting (T_{M}^{onset}) and the onset temperature of crystallization (T_{C}^{onset}). Thus:

W=T_{M}^{onset}−T_{C}^{onset}

In the context of the present invention, the terms “sintering window (W)”, “size of the sintering window (W)” and “difference between the onset temperature of melting (T_{M}^{onset}) and the onset temperature of crystallization (T_{C}^{onset})” have the same meaning and are used synonymously.

The determination of the sintering window (W_{SP}) of the sinter powder (SP) and the determination of the sintering window (W_{A}) of component (A) are effected as described above. The sample used in that case for determination of the sintering window (W_{SP}) of the sinter powder (SP) is the sinter powder (SP), and the sample used for determination of the sintering window (W_{A}) of component (A) is component (A).

Sinter Powder (SP)

According to the invention, the sinter powder (SP) comprises at least one semicrystalline polyamide as component (A), and at least one nylon-6I/6T as component (B).

In the context of the present invention the terms “component (A)” and “at least one semicrystalline polyamide” are used synonymously and therefore have the same meaning.

The same applies to the terms “component (B)” and “at least one nylon-6I/6T”. These terms are likewise used synonymously in the context of the present invention and therefore have the same meaning.

The sinter powder (SP) may comprise components (A) and (B) in any desired amounts. For example, the sinter powder (SP) comprises in the range from 60% to 95% by weight of component (A) and in the range from 5% to 40% by weight of component (B), based in each case on the sum total of the percentages by weight of components (A) and (B), preferably based on the total weight of the sinter powder (SP).

Preferably, the sinter powder (SP) comprises in the range from 60% to 85% by weight of component (A) and in the range from 15% to 40% by weight of component (B), based in each case on the sum total of the percentages by weight of components (A) and (B), preferably based on the total weight of the sinter powder (SP).

More preferably, the sinter powder (SP) comprises in the range from 75% to 85% by weight of component (A) and in the range from 15% to 25% by weight of component (B), based in each case on the sum total of the percentages by weight of components (A) and (B), preferably based on the total weight of the sinter powder (SP).

The present invention therefore also provides a process in which the sinter powder (SP) comprises in the range from 60% to 85% by weight of component (A) and in the range from 15% to 40% by weight of component (B), based in each case on the sum total of the percentages by weight of components (A) and (B).

In a further preferred embodiment, the sinter powder (SP) comprises in the range from 75% to 90% by weight of component (A) and in the range from 10% to 25% by weight of component (B), based in each case on the sum total of the percentages by weight of components (A) and (B), preferably based on the total weight of the sinter powder (SP).

The sinter powder (SP) may also additionally comprise at least one additive selected from the group consisting of antinucleating agents, stabilizers, end group functionalizers and dyes.

The present invention therefore also provides a process in which the sinter powder (SP) additionally comprises at least one additive selected from the group consisting of antinucleating agents, stabilizers, end group functionalizers and dyes.

An example of a suitable antinucleating agent is lithium chloride. Suitable stabilizers are, for example, phenols, phosphites and copper stabilizers. Suitable end group functionalizers are, for example, terephthalic acid, adipic acid and propionic acid. Preferred dyes are, for example, selected from the group consisting of carbon black, neutral red, inorganic black dyes and organic black dyes.

More preferably, the at least one additive is selected from the group consisting of stabilizers and dyes.

Phenols are especially preferred as stabilizer,

Therefore, the at least one additive is especially preferably selected from the group consisting of phenols, carbon black, inorganic black dyes and organic black dyes.

The present invention therefore also provides a process in which the sinter powder (SP) additionally comprises at least one additive selected from the group consisting of phenols, carbon black, inorganic black dyes and organic black dyes.

Carbon black is known to those skilled in the art and is available, for example, under the Spezialschwarz 4 trade name from Evonik, under the Printex U trade name from Evonik, under the Printex 140 trade name from Evonik, under the Spezialschwarz 350 trade name from Evonik or under the Spezialschwarz 100 trade name from Evonik.

A preferred inorganic black dye is available, for example, under the Sicopal Black K0090 trade name from BASF SE or under the Sicopal Black K0095 trade name from BASF SE.

An example of a preferred organic black dye is nigrosin.

The sinter powder (SP) may comprise, for example, in the range from 0.1% to 10% by weight of the at least one additive, preferably in the range from 0.2% to 5% by weight and especially preferably in the range from 0.3% to 2.5% by weight, based in each case on the total weight of the sinter powder (SP).

The sum total of the percentages by weight of components (A), (B) and optionally of the at least one additive typically add up to 100% by weight.

The sinter powder (SP) comprises particles. These particles have, for example, a size in the range from 10 to 250 μm, preferably in the range from 15 to 200 μm, more preferably in the range from 20 to 120 μm and especially preferably in the range from 20 to 110 μm.

The sinter powder (SP) of the invention has, for example,

a D10 in the range from 10 to 30 μm,

a D50 in the range from 25 to 70 μm and

a D90 in the range from 50 to 150 μm.

Preferably, the sinter powder (SP) of the invention has

a D10 in the range from 20 to 30 μm,

a D50 in the range from 40 to 60 μm and

a D90 in the range from 80 to 110 μm.

The present invention therefore also provides a process in which the sinter powder (SP) has

a D10 in the range from 10 to 30 μm,

a D50 in the range from 25 to 70 μm and

a D90 in the range from 50 to 150 μm.

In the context of the present invention, the “D10” is understood to mean the particle size at which 10% by volume of the particles based on the total volume of the particles are smaller than or equal to D10 and 90% by volume of the particles based on the total volume of the particles are larger than D10. By analogy, the “D50” is understood to mean the particle size at which 50% by volume of the particles based on the total volume of the particles are smaller than or equal to D50 and 50% by volume of the particles based on the total volume of the particles are larger than D50. Correspondingly, the “D90” is understood to mean the particle size at which 90% by volume of the particles based on the total volume of the particles are smaller than or equal to D90 and 10% by volume of the particles based on the total volume of the particles are larger than D90.

To determine the particle sizes, the sinter powder (SP) is suspended in a dry state using compressed air or in a solvent, for example water or ethanol, and this suspension is analyzed. The D10, D50 and D90 values are determined by laser diffraction using a Malvern Master Sizer 3000. Evaluation is by means of Fraunhofer diffraction.

The sinter powder (SP) typically has a melting temperature (T_{M}) in the range from 180 to 270° C. Preferably, the melting temperature (T_{M}) of the sinter powder (SP) is in the range from 185 to 260° C. and especially preferably in the range from 190 to 245° C.,

The present invention therefore also provides a process in which the sinter powder (SP) has a melting temperature (T_{M}) in the range from 180 to 270° C.

The melting temperature (T_{M}) is determined in the context of the present invention by means of differential scanning calorimetry (DSC). As described above, it is customary to measure a heating run (H) and a cooling run (C). This gives a DSC diagram as shown by way of example in FIG. 1. The melting temperature (T_{M}) is then understood to mean the temperature at which the melting peak of the heating run (H) of the DSC diagram has a maximum. The melting temperature (T_{M}) is thus different than the onset temperature of melting (T_{M}^{onset}). Typically, the melting temperature (T_{M}) is above the onset temperature of melting (T_{M}^{onset}).

The sinter powder (SP) typically also has a crystallization temperature (T_{C}) in the range from 120 to 190° C. Preferably, the crystallization temperature (T_{C}) of the sinter powder (SP) is in the range from 130 to 180° C. and especially preferably in the range from 140 to 180° C.

The present invention therefore also provides a process in which the sinter powder (SP) has a crystallization temperature (T_{C}) in the range from 120 to 190° C.

The crystallization temperature (T_{C}) is determined in the context of the present invention by means of differential scanning calorimetry (DSC). As described above, this customarily involves measuring a heating run (H) and a cooling run (C). This gives a DSC diagram as shown by way of example in FIG. 1. The crystallization temperature (T_{C}) is then the temperature at the minimum of the crystallization peak of the DSC curve. The crystallization temperature (T_{C}) is thus different than the onset temperature of crystallization (T_{C}^{onset}). The crystallization temperature (T_{C}) is typically below the onset temperature of crystallization (T_{C}^{onset}).

The sinter powder (SP) typically also has a sintering window (W_{SP}). The sintering window (W_{SP}) is, as described above, the difference between the onset temperature of melting (T_{M}^{onset}) and the onset temperature of crystallization (T_{C}^{onset}). The onset temperature of melting (T_{M}^{onset}) and the onset temperature of crystallization (T_{C}^{onset}) are determined as described above.

The sintering window (W_{SP}) of the sinter powder (SP) is preferably in the range from 15 to 40 K (kelvin), more preferably in the range from 20 to 35 K and especially preferably in the range from 20 to 33 K.

The present invention therefore also provides a process in which the sinter powder

(SP) has a sintering window (W_{SP}), where the sintering window (W_{SP}) is the difference between the onset temperature of melting (T_{M}^{onset}) and the onset temperature of crystallization (T_{M}^{onset}) and where the sintering window (W_{SP}) is in the range from 15 to 40 K.

The sinter powder (SP) can be produced by any method known to those skilled in the art. Preferably, the sinter powder (SP) is produced by grinding components (A) and (B) and optionally the at least one additive.

The production of the sinter powder (SP) by grinding can be conducted by any method known to those skilled in the art. For example, component (A) and component (B) and optionally the at least one additive are introduced into a mill and ground therein.

Suitable mills include all mills known to those skilled in the art, for example classifier mills, opposed jet mills, hammer mills, ball mills, vibratory mills or rotor mills.

The grinding in the mill can likewise be effected by any method known to those skilled in the art. For example, the grinding can take place under inert gas and/or while cooling with liquid nitrogen. Cooling with liquid nitrogen is preferred.

The grinding temperature is as desired. The grinding is preferably conducted at liquid nitrogen temperatures, for example at a temperature in the range of −210 to −195° C.

The present invention therefore also provides a process in which the sinter powder (SP) is produced by grinding components (A) and (B) at a temperature in the range from −210 to −195° C.

Component (A), component (B) and optionally the at least one additive can be introduced into the mill by any method known to those skilled in the art. For example, component (A) and component (B) and optionally the at least one additive can be introduced separately into the mill and ground therein and hence mixed with one another. It is also possible and preferable in accordance with the invention that component (A) and component (B) and optionally the at least one additive are compounded with one another and then introduced into the mill.

Processes for compounding are known as such to the person skilled in the art. For example, component (A) and component (B) and optionally the at least one additive can be compounded in an extruder, then extruded therefrom and then introduced into the mill.

Component (A)

Component (A) is at least one semicrystalline polyamide.

According to the invention, “at least one semicrystalline polyamide” means either exactly one semicrystalline polyamide or a mixture of two or more semicrystalline polyamides.

“Semicrystalline” in the context of the present invention means that the polyamide has an enthalpy of fusion Δ H2_{(A)} of greater than 45 J/g, preferably of greater than 50 J/g and especially preferably of greater than 55 J/g, in each case measured by means of differential scanning calorimetry (DSC) according to ISO 11357-4:2014.

Component (A) of the invention also preferably has an enthalpy of fusion Δ H2_{(A)} of less than 200 J/g, more preferably of less than 150 J/g and especially preferably of less than 100 J/g, in each case measured by means of differential scanning calorimetry (DSC) according to ISO 11357-4:2014.

According to the invention, component (A) comprises at least one unit selected from the group consisting of —NH—(CH₂)ₘ—NH— units where m is 4, 5, 6, 7 or 8, —CO—(CH₂)ₙ—NH— units where n is 3, 4, 5, 6 or 7 and —CO—(CH₂)ₒ—CO— units where o is 2, 3, 4, 5 or 6.

Preferably, component (A) comprises at least one unit selected from the group consisting of —NH—(CH₂)ₘ—NH— units where m is 5, 6 or 7, —CO—(CH₂)ₙ—NH— units where n is 4, 5 or 6 and —CO—(CH₂)ₒ—CO— units where o is 3, 4 or 5.

Especially preferably, component (A) comprises at least one unit selected from the group consisting of —NH—(CH₂)₆—NH— units, —CO—(CH₂)₅—NH— units and —CO—(CH₂)₄—CO— units.

If component (A) comprises at least one unit selected from the group consisting of —CO—(CH₂)ₙ—NH— units, these units derive from lactams having 5 to 9 ring members, preferably from lactams having 6 to 8 ring members, especially preferably from lactams having 7 ring members.

Lactams are known to those skilled in the art. Lactams are generally understood in accordance with the invention to mean cyclic amides. According to the invention, these have 4 to 8 carbon atoms in the ring, preferably 5 to 7 carbon atoms and especially preferably 6 carbon atoms.

For example, the lactams are selected from the group consisting of butyro-4-lactam (γ-lactam, γ-butyrolactam), 2-piperidinone (δ-lactam; δ-valerolactam), hexano-δ-lactam (ϵ-lactam; ϵ-caprolactam), heptano-7-lactam (ζ-lactam; ζ-heptanolactarn) and octano-8-lactam (η-lactam; η-octanolactam).

Preferably, the lactams are selected from the group consisting of 2-piperidinone (δ-lactam; δ-valerolactam), hexano-δ-lactam (ϵ-lactam; ϵ-caprolactam) and heptano-7-lactam (ζ-lactam; ζ-heptanolactam). Especially preferred is ϵ-caprolactam.

If component (A) comprises at least one unit selected from the group consisting of —NH—(CH₂)ₘ—NH— units, these units derive from diamines. In that case, component (A) is thus obtained by reaction of diamines, preferably by reaction of diamines with dicarboxylic acids.

Suitable diamines comprise 4 to 8 carbon atoms, preferably 5 to 7 carbon atoms and especially preferably 6 carbon atoms.

Diamines of this kind are selected, for example, from the group consisting of 1,4-diaminobutane (butane-1,4-diamine; tetramethylenediamine; putrescine), 1,5-diaminopentane (pentamethylenediamine; pentane-1,5-diamine; cadaverine), 1,6-diaminohexane (hexamethylenediamine; hexane-1,6-diamine), 1,7-diaminoheptane and 1,8-diaminooctane. Preference is given to the diamines selected from the group consisting of 1,5-diaminopentane, 1,6-diaminohexane and 1,7-diaminoheptane. 1,6-Diaminohexane is especially preferred.

If component (A) comprises at least one unit selected from the group consisting of —CO—(CH₂)ₒ—CO— units, these units are typically derived from dicarboxylic acids. In that case, component (A) was thus obtained by reaction of dicarboxylic acids, preferably by reaction of dicarboxylic acids with diamines.

In that case, the dicarboxylic acids comprise 4 to 8 carbon atoms, preferably 5 to 7 carbon atoms and especially preferably 6 carbon atoms.

These dicarboxylic acids are, for example, selected from the group consisting of butanedioic acid (succinic acid), pentanedioic acid (glutaric acid), hexanedioic acid (adipic acid), heptanedioic acid (pimelic acid) and octanedioic acid (suberic acid). Preferably, the dicarboxylic acids are selected from the group consisting of pentanedioic acid, hexanedioic acid and heptanedioic acid; hexanedioic acid is especially preferred.

Component (A) may additionally comprise further units. For example units which derive from lactams having 10 to 13 ring members, such as caprylolactam and/or laurolactam.

In addition, component (A) may comprise units derived from dicarboxylic acid alkanes (aliphatic dicarboxylic acids) having 9 to 36 carbon atoms, preferably 9 to 12 carbon atoms, and more preferably 9 to 10 carbon atoms. Aromatic dicarboxylic acids are also suitable.

Examples of dicarboxylic acids include azelaic acid, sebacic acid, dodecanedioic acid and also terephthalic acid and/or isophthalic acid.

It is also possible for component (A) to comprise units, for example, derived from m-xylylenediamine, di(4-aminophenyl)methane, di(4-aminocyclohexyl)methane, 2,2-di(4-aminophenyl)propane and 2,2-di(4-aminocyclohexyl)propane and/or 1,5-diamino-2-methylpentane.

The following nonexhaustive list comprises the preferred components (A) for use in the sinter powder (SP) of the invention and the monomers present:

AB polymers:

| | |
|---|---|
| PA 4 | pyrrolidone |
| PA 6 | ε-caprolactam |
| PA 7 | enantholactam |
| PA 8 | caprylolactam |

AA/BB polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 6T | hexamethylenediamine, terephthalic acid |
| PA MXD6 | m-xylylenediamine, adipic acid |
| PA 6/6I | (see PA 6), hexamethylenediamine, isophthalic acid |
| PA 6/6T | (see PA 6 and PA 6T) |
| PA 6/66 | (see PA 6 and PA 66) |
| PA 6/12 | (see PA 6), laurylolactam |
| PA 66/6/610 | (see PA 66, PA 6 and PA 610) |
| PA 6I/6T/PACM | as PA 6I/6T and diaminodicyclohexylmethane |
| PA 6/6I6T | (see PA 6 and PA 6T), hexamethylenediamine, |
| | isophthalic acid |

Preferably, component (A) is therefore selected from the group consisting of PA 6, PA 6,6, PA 6,10, PA 6,12, PA 6,36, PA 6/6,6, PA 6/6I6T, PA 6/6T and PA 6/6I.

Especially preferably, component (A) is selected from the group consisting of PA 6, PA 6,10, PA 6,6/6, PA 6/6T and PA 6,6. More preferably, component (A) is selected from the group consisting of PA 6 and PA 6/6,6. Most preferably, component (A) is PA 6.

The present invention therefore also provides a process in which component (A) is selected from the group consisting of PA 6, PA 6,6, PA 6,10, PA 6,12, PA 6,36, PA 6/6,6, PA 6/6I6T, PA 6/6T and PA 6/6I.

Component (A) generally has a viscosity number of 70 to 350 mL/g, preferably of 70 to 240 mL/g: According to the invention; the viscosity number is determined from a 0.5% by weight solution of component (A) and in 96% by weight sulfuric acid at 25° C. to ISO 307.

Component (A) preferably has a weight-average molecular weight (M_{W}) in the range from 500 to 2 000 000 g/mol, more preferably in the range from 5000 to 500 000 g/mol and especially preferably in the range from 10 000 to 100 000 g/mol. The weight-average molecular weight (Mw) is determined according to ASTM D4001.

Component (A) typically has a melting temperature (T_{M}). The melting temperature (T_{M}) of component (A) is, for example, in the range from 70 to 300° C. and preferably in the range from 220 to 295° C. The melting temperature (T_{M}) of component (A) is determined by means of differential scanning calorimetry as described above for the melting temperature (T_{M}) of the sinter powder (SP).

Component (A) also typically has a glass transition temperature (T_{G}). The glass transition temperature (TG) of component (A) is, for example, in the range from 0 to 110° C. and preferably in the range from 40 to 105° C.

The glass transition temperature (T_{G}) of component (A) is determined by means of differential scanning calorimetry. For determination, in accordance with the invention, first a first heating run (H1), then a cooling run (C) and subsequently a second heating run (H2) is measured on a sample of component (A) (starting weight about 8.5 g). The heating rate in the first heating run (H1) and in the second heating run (H2) is 20 K/min; the cooling rate in the cooling run (C) is likewise 20 K/min. In the region of the glass transition of component (A), a step is obtained in the second heating run (H2) in the

DSC diagram. The glass transition temperature (T_{G}) of component (A) corresponds to the temperature at half the step height in the DSC diagram.

Component (B)

According to the invention, component (B) is at least one nylon-6I/6T.

In the context of the present invention, “at least one nylon-6I/6T” means either exactly one nylon-6I/6T or a mixture of two or more nylons-6I/6T.

Nylon-6I/6T is a copolymer of nylon-6I and nylon-6T.

Preferably, component (B) consists of units derived from hexamethylenediamine, from terephthalic acid and from isophthalic acid.

In other words, component (B) is thus a copolymer prepared proceeding from hexamethylenediamine, terephthalic acid and isophthalic acid.

Component (B) is preferably a random copolymer,

The at least one nylon-6I/6T used as component (B) may comprise any desired proportions of 6I units and of 6T units. Preferably, the molar ratio of 6I units to 6T units is in the range from 1:1 to 3:1, more preferably in the range from 1.5:1 to 2.5:1 and especially preferably in the range from 1.8:1 to 2.3:1.

Component (B) is an amorphous copolyamide.

“Amorphous” in the context of the present invention means that the pure component (B) does not have any melting point in differential scanning calorimetry (DSC) measured according to ISO 11357.

Component (B) has a glass transition temperature (T_{G}). The glass transition temperature (T_{G}) of component (B) is typically in the range from 100 to 150° C., preferably in the range from 115 to 135° C. and especially preferably in the range from 120 to 130° C. The glass transition temperature (T_{G}) of component (B) is determined by means of differential scanning calorimetry as described above for the determination of the glass transition temperature (T_{G}) of component (A).

The MVR (275° C./5 kg) (melt volume flow rate) is preferably in the range from 50 mL/10 min to 150 mL/10 min, more preferably in the range from 95 mL/10 min to 105 mL/10 min.

The zero shear rate viscosity no of component (B) is, for example, in the range from 770 to 3250 Pas. The zero shear rate viscosity no is determined with a “DHR-1” rotary viscometer from TA Instruments and a plate-plate geometry with a diameter of 25 mm and a plate separation of 1 mm. Unequilibrated samples of component (B) are dried at 80° C. under reduced pressure for 7 days and these are then analyzed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

Component (B) has an amino end group concentration (AEG) which is preferably in the range from 30 to 45 mmol/kg and especially preferably in the range from 35 to 42 mmol/kg.

For determination of the amino end group concentration (AEG), 1 g of component (B) is dissolved in 30 mL of a phenol/methanol mixture (volume ratio of phenol:methanol 75:25) and then subjected to potentiometric titration with 0.2 N hydrochloric acid in water.

Component (B) has a carboxyl end group concentration (CEG) which is preferably in the range from 60 to 155 mmol/kg and especially preferably in the range from 80 to 135 mmol/kg.

For determination of the carboxylic end group concentration (CEG), 1 g of component (B) is dissolved in 30 mL of benzyl alcohol. This is followed by visual titration at 120° C. with 0.05 N potassium hydroxide solution in water.

Shaped Body

According to the invention, the process of selective laser sintering described further up affords a shaped body. The sinter powder (SP) melted by the laser in the selective exposure resolidifies after the exposure and thus forms the shaped body of the invention. The shaped body can be removed from the powder bed directly after the solidification of the molten sinter powder (SP). It is likewise possible first to cool the shaped body and only then to remove it from the powder bed. Any adhering particles of the sinter powder (SP) which has not yet melted can be mechanically removed from the surface by known methods. Methods for surface treatment of the shaped body include, for example, vibratory grinding or barrel polishing, and also sandblasting, glass bead blasting or microbead blasting.

It is also possible to subject the shaped bodies obtained to further processing or, for example, to treat the surfaces.

The shaped body of the invention comprises, for example, in the range from 60% to 95% by weight of component (A) and in the range from 5% to 40% by weight of component (B), based in each case on the total weight of the shaped body.

Preferably, the shaped body of the invention comprises in the range from 60% to 85% by weight of component (A) and in the range from 15% to 40% by weight of component (B), based in each case on the total weight of the shaped body.

More preferably, the shaped body of the invention comprises in the range from 75% to 85% by weight of component (A) and in the range from 15% to 25% by weight of component (B), based in each case on the total weight of the shaped body.

In a further preferred embodiment, the shaped body of the invention comprises in the range from 75% to 90% by weight of component (A) and in the range from 10% to 25% by weight of component (B), based in each case on the total weight of the shaped body.

According to the invention, component (A) is the component (A) that was present in the sinter powder (SP); component (B) is likewise the component (B) that was present in the sinter powder (SP).

If the sinter powder (SP) comprises the at least one additive, the shaped body obtained in accordance with the invention also comprises the at least one additive.

It will be clear to the person skilled in the art that, as a result of the exposure of the sinter powder (SP) to the laser, component (A), component (B) and optionally the at least one additive can enter into chemical reactions and be altered as a result. Reactions of this kind are known to those skilled in the art.

Preferably, component (A), component (B) and optionally the at least one additive do not enter into any chemical reaction as a result of the exposure of the sinter powder (SP) to the laser; instead, the sinter powder (SP) merely melts.

The present invention therefore also provides a shaped body obtainable by the process of the invention.

The use of a nylon-6I/6T in the sinter powder (SP) of the invention broadens the sintering window (W_{SP}) of the sinter powder (SP) compared to the sintering window (W_{A}) of component (A).

The present invention therefore also provides for the use of a nylon-6I/6T in a sinter powder (SP) comprising the following components:
(A) at least one semicrystalline polyimide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
(B) at least one nylon-6I/6T.

for broadening the sintering window (W_{SP}) of the sinter powder (SP) compared to the sintering window (W_{A}) of component (A), where the sintering window (W_{SP}; W_{A}) in each case is the difference between the onset temperature of melting (T_{M}^{onset}) and the onset temperature of crystallization (T_{C}^{onset}).

For example, the sintering window (W_{A}) of component (A) is in the range from 5 to 30 K (kelvin), preferably in the range from 9 to 25 K and especially preferably in the range from 15 to 21 K.

The sintering window (W_{SP}) of the sinter powder (SP) broadens with respect to the sintering window (W_{A}) of component (A), for example, by 2 to 20° C., preferably by 2.5 to 18° C. and especially preferably by 4 to 12° C.

It will be apparent that the sintering window (W_{SP}) of the sinter powder (SP) is broader than the sintering window (W_{A}) of component (A) present in the sinter powder (SP).

The invention is elucidated in detail hereinafter by examples, without restricting it thereto.

### EXAMPLES

The following components are used:

Semicrystalline polyamide (component (A)):

| | | |
|---|---|---|
| (P1a) | nylon-6 | (Ultramid ® B27, BASF SE) |
| (P1b) | nylon-6 | (Ultramid ® B24, BASF SE) |
| (P1c) | nylon-6 | (Ultramid ® B22, BASF SE) |
| (P2) | nylon-6,10 | (Ultramid ® S3K Balance, BASF SE) |
| (P3) | nylon-6,6/6 | (copolymer, BASF SE) |
| (P4) | nylon-6,6 | (Ultramid ® A27, BASF SE) |
| (P5) | nylon PA6/6I6T | (copolymer, prepared as described below, BASF |
| | | SE) |
| (P6) | nylon PA6/66 | (Ultramid ® C33, BASF SE) |
| (P7) | nylon-6,36 | (experimental product formed from |
| | | hexamethylenediamine and Pripol, from Croda, |
| | | BASF SE) |
| (P8) | nylon PA6/6I6T | (copolymer, prepared as described below, BASF |
| | | SE) |
| (P9) | nylon PA6/6I6T | (copolymer, prepared as described below, BASF |
| | | SE) |
| (P10) | nylon PA6/6I6T | (copolymer, prepared as described below, BASF |
| | | SE) |
| (P11) | nylon PA12 | (Grilamid L16, EMS) |
| (P12) | nylon PA6T/6 | (Ultramid ® T, BASF SE) |
| (P13) | nylon-6/6,6 | (Ultramid ® C33, BASF SE) |

Amorphous polyamide (AP) (component (B)):

| | | |
|---|---|---|
| (AP1) | nylon DTDI | (formed from benzene-1,3-dicarboxylic acid, |
| | | hexane-1,6-diamine and 2-methylpentane-1,5- |
| | | diamine) (PPA 201, Invista) |
| (AP2) | nylon MACM.14 | (Rilsan Clear G350, Arkema) |
| (AP3) | nylon-12/MACM.I | (Grilamid TR55, EMS) |
| (AP4) | nylon-12/MACM.12 | (Grilamid TR90, EMS) |
| (AP5) | nylon PACM.12 | (Trogamid CX 7323, Evonik) |
| (AP6) | nylon-6I/6T | (Grivory G16, EMS), with a molar ratio of 6I:6T of |
| | | 1.9:1 |
| (AP7) | nylon-6I/6T | (Grivory G21, EMS), with a molar ratio of 6I:6T of |
| | | 2.1:1 |
| (AP8) | nylon-6I/6T | (Selar PA3426 R, DuPont), with a molar ratio of |
| | | 6I:6T of 2.2:1 |

Additive:

| | | |
|---|---|---|
| (A1) | Irganox 1098 | (N,N′-hexane-1,6-diylbis(3-(3,5-di-tert-butyl-4- |
| | | hydroxyphenylpropionamide)), BASF SE) |

Preparation of Nylon-6/6I6T Copolymers

For preparation of the nylon-6/6I6T copolymers (P5, P8, P9, P10), the monomers specified in table 1 were polymerized in the molar ratios specified in table 1 in the presence of water and sodium hypophosphite. 90% by weight of monomers, 0.1% by weight of sodium hypophosphite and 10% by weight of water were used, based on the sum total of the percentages by weight of the monomers, sodium hypophosphite and water.

The polymerization took place at a target temperature of 280° C. (actual temperature in the reactor 270° C.) in water over a period of 95 minutes. The mixture was heated for 15 min, then the pressure of 14 bar was kept constant for 30 min and finally released at constant temperature over the course of 45 min.

TABLE 1

| | | Hexamethylene- | Terephthalic | Isophthalic |
|---|---|---|---|---|
| | Caprolactam | diamine | acid | acid |
| | [mol %] | [mol %] | [mol %] | [mol %] |
| P5 | 82.4 | 8.8 | 2.6 | 6.1 |
| P8 | 86.8 | 6.6 | 1.98 | 4.62 |
| P9 | 91.2 | 4.4 | 1.3 | 3.1 |
| P10 | 95.6 | 2.2 | 0.66 | 1.54 |

Table 2 reports essential parameters of the semicrystalline polyamides (component (A)) used.

Table 3 reports the essential parameters for the amorphous polyamides (component (B)) used.

TABLE 2

| | | | | | | Zero viscosity |
|---|---|---|---|---|---|---|
| | | AEG | CEG | T_{M} | T_{G} | η₀ at 240° C. |
| | type | [mmol/kg] | [mmol/kg] | [° C.] | [° C.] | [Pas] |
| P1a | PA 6 | 36 | 54 | 220.0 | 53 | 399 |
| P1b | PA 6 | 42.5 | 78 | 220.2 | 54 | 180 |
| P1c | PA 6 | 58.3 | 93 | 221.0 | 55 | 94 |
| P2 | PA 6,10 | | | 222.4 | 44 | 427 |
| P3 | PA 66/6 | | | 240.2 | 53 | 111 (at 260° C.) |
| P4 | PA 66 | | | 261.5 | 59 | 202 (at 280° C.) |
| P5 | PA 6/6I6T | 39.1 | 67 | 175.6 | 59 | 3050 |
| P6 | PA 6/66 | | | 193.7 | 50 | 2300 |
| P7 | PA 6,36 | | | 71.1/82.2 | 2 | — |
| P8 | PA 6/6I6T | | | 187.1 | 61 | — |
| P9 | PA 6/6I6T | | | 201.4 | 60 | — |
| P10 | PA 6/6I6T | | | 209.3 | 57 | — |
| P11 | PA 12 | | | 177.2 | 37 | |
| P12 | PA 6T/6 | | | 291.1 | 105 | 720 (at 315° C.) |
| P13 | PA 6/6,6 | | | 195.3 | 50 | 2300 (at 220° C.) |

TABLE 3

| | | | | | Zero |
|---|---|---|---|---|---|
| | | | | | viscosity |
| | | AEG | CEG | T_{G} | η₀ at 240° C. |
| | Type | [mmol/kg] | [mmol/kg] | [° C.] | [Pas] |
| AP1 | PA DTDI | 46 | 43 | 143 | 2550 |
| AP2 | PA MACM.14 | 49 | 51 | 141 | 4650 |
| AP3 | PA 12/MACM.I | 62 | 71 | 159 | 10800 |
| AP4 | PA 12/MACM.12 | 60 | 63 | 149 | 5000 |
| AP5 | PA PACM 12 | 57 | 56 | 135 | 2220 (at |
| | | | | | 260° C.) |
| AP6 | PA 6I6T | 37 | 86 | 125 | 770 |
| AP7 | PA 6I6T | 41 | 90 | 126 | 3250 |
| AP8 | PA 6I6T | 41 | 132 | 128 | 2070 |

AEG indicates the amino end group concentration. This is determined by means of titration. For determination of the amino end group concentration (AEG), 1 g of the component (semicrystalline polyamide or amorphous polyamide) was dissolved in 30 mL of a phenol/methanol mixture (volume ratio of phenol:methanol 75:25) and then subjected to potentiometric titration with 0.2 N hydrochloric acid in water.

The CEG indicates the carboxyl end group concentration. This is determined by means of titration. For determination of the carboxylic end group concentration (CEG), 1 g of the component (semicrystalline polyamide or amorphous polyamide) was dissolved in 30 mL of benzyl alcohol. This was followed by visual titration at 120° C. with 0.05 N potassium hydroxide solution in water.

The melting temperature (T_{M}) of the semicrystalline polyamides and the glass transition temperatures (Ts) of the semicrystalline polyamides and the amorphous polyamides were each determined by means of differential scanning calorimetry. For determination of the melting temperature (T_{M}), as described above, a first heating run (H1) at a heating rate of 20 K/min was measured. The melting temperature (T_{M}) then corresponded to the temperature at the maximum of the melting peak of the heating run (H1).

For determination of the glass transition temperature (T_{G}), after the first heating run (H1), a cooling run (C) and subsequently a second heating run (H2) were measured. The cooling run was measured at a cooling rate of 20 K/min; the first heating run (H1) and the second heating run (H2) were measured at a heating rate of 20 K/min. The glass transition temperature (T_{G}) was then determined as described above at half the step height of the second heating run (H2).

The zero shear rate viscosity no was determined with a “DHR-1” rotary viscometer from TA Instruments and a plate-plate geometry with a diameter of 25 mm and a plate separation of 1 mm. Unequilibrated samples were dried at 80° C. under reduced pressure for 7 days and these were then analyzed with a time-dependent frequency sweep (sequence test) with an angular frequency range of 500 to 0.5 rad/s. The following further analysis parameters were used: deformation: 1.0%, analysis temperature: 240° C., analysis time: 20 min, preheating time after sample preparation: 1.5 min.

Blends of Semicrystaiiine Polyamides

For production of blends of semicrystalline polyamides, the semicrystalline polyamides were compounded in the ratios specified in table 4 in a twin-screw extruder (ZSK 18) at 260° C., a speed of 200 rpm and a throughput of 5 kg/h, with subsequent strand pelletization.

The blends obtained were subsequently characterized. The melting temperature (T_{M}) was determined as described above.

The crystallization temperature (T_{C}) was determined by means of differential scanning calorimetry. For this purpose, first a heating run (H) at a heating rate of 20 K/min and then a cooling run (C) at a cooling rate of 20 K/min were measured. The crystallization temperature (T_{C}) is the temperature at the extreme of the crystallization peak.

The magnitude of the complex shear viscosity was determined by means of a plate-plate rotary rheometer at an angular frequency of 0.5 rad/s and a temperature of 240° C. A “DNR-1” rotary viscometer from TA Instruments was used, with a diameter of 25 mm and a plate separation of 1 mm. Unequilibrated samples were dried at 80° C. under reduced pressure for 7 days and these were then analyzed with a time-dependent frequency sweep (sequence test) with an angular frequency range of 500 to 0.5 rad/s. The following further analysis parameters were used: deformation: 1.0%, analysis time: 20 min, preheating time after sample preparation: 1.5 min. The sintering window (W) was determined, as described above, as the difference between the onset temperature of melting (T_{M}^{onset}) and the onset temperature of crystallization (T_{C}^{onset}).

The results can be seen in table 5.

TABLE 4

| | (P1a) | (P2) | (P4) | (P6) | (P7) |
|---|---|---|---|---|---|
| Example | [% by wt.] | [% by wt.] | [% by wt.] | [% by wt.] | [% by wt.] |
| Polyamide | PA 6 | PA 6,10 | PA 66 | PA 6/66 | PA 6,36 |
| C1 | 100 | | | | |
| C2 | 80 | 20 | | | |
| C3 | 90 | | 10 | | |
| C4 | 90 | | | 10 | |
| C5 | 80 | | | 20 | |
| C6 | 80 | | | | 20 |

TABLE 5

| | Magnitude of | | | |
|---|---|---|---|---|
| | complex | | | |
| | viscosity at 0.5 | | | Sintering |
| | rad/s 240° C. | T_{M} | T_{C} | window |
| Example | [Pas] | [° C.] | [° C.] | W [K] |
| C1 | 362 | 220.6 | 184.3 | 21.3 |
| C2 | 536 | 220.8 | 187.6 | 18.1 |
| C3 | n.d. (not | 218.7/256.3 | 195.6 | 8.3 |
| | determined) | | | |
| C4 | 425 | 219.3 | 181.4 | 21.1 |
| C5 | 457 | 219.3 | 183.9 | 21.7 |
| C6 | — | 70.3/81.0/ | 187.1 | 17.5 |
| | | 220.2 | | |

The use of semicrystalline polyamides as a blend with nylon-6 does not lead to broadening of the sintering window compared to that of pure PA 6 (C1), but in some cases actually makes it much smaller.

Blends of Semicrystalline Polyamides with Amorphous Polyamides

For production of blends of semicrystalline polyamides with amorphous polyamides, the components specified in table 6 were compounded in the ratios specified in table 6 in a DSM 15 cm³ miniextruder (DSM-Micro15 microcompounder) at a speed of 80 rpm (revolutions per minute) at 260° C. for a mixing time of 3 min (minutes) and then extruded. The extrudates obtained were then ground in a mill and sieved to a particle size of <200 μm.

The blends obtained were characterized as described above. The broadening of the sintering window compared to PA 6 corresponds to the difference between the sintering window (W_{SP}) of the blend (of the sinter powder (SP)) and the sintering window (W_{A}) of PA 6 (component (A)). The results are shown in table 7.

TABLE 6

| | (P1a) | (AP1) | (AP2) | (AP3) | (AP4) | (AP5) | (AP6) |
|---|---|---|---|---|---|---|---|
| Example | [% by wt.] | [% by wt.] | [% by wt.] | [% by wt.] | [% by wt.] | [% by wt.] | [% by wt.] |
| Polyamide | PA 6 | PA DTDI | PA | PA 12/ | PA12/ | PA | PA 6I6T |
| | | | MACM.14 | MACM.I | MACM.12 | PACM.12 | |
| C7 | 100 | | | | | | |
| C8 | 79 | 21 | | | | | |
| C9 | 79 | | 21 | | | | |
| C10 | 79 | | | 21 | | | |
| C11 | 79 | | | | 21 | | |
| C12 | 79 | | | | | 21 | |
| I13 | 79 | | | | | | 21 |

TABLE 7

| | Magnitude | | | | | |
|---|---|---|---|---|---|---|
| | of complex | | | | Broadening | |
| | viscosity | | | | of sintering | |
| | at 0.5 rad/s, | | | Sintering | window | |
| | 240° C. | T_{M} | T_{C} | window W | compared to | T_{G} |
| Example | [Pas] | [° C.] | [° C.] | [K] | (P1a) | [° C.] |
| C7 | 370 | 219.7 | 187.8 | 16.7 | — | 53 |
| C8 | n.d. | 218.8 | 183.0 | 20.1 | 3.4 | 68 |
| C9 | n.d. | 219.5 | 186.4 | 19.2 | 2.5 | 52 |
| C10 | n.d. | 218.9 | 185.2 | 19.7 | 3.0 | 55 |
| C11 | 1020 | 219.9 | 185.4 | 21.0 | 4.3 | 53 |
| C12 | 1960 | 219.6/247.4/257.7 | 186.8 | n.d. | — | — |
| I13 | 463 | 219.5 | 173.2 | 24.5 | 7.8 | 68 |

It is clearly apparent that, when nylon-6I/6T only is used as the amorphous polyamide (component (B)), distinct broadening of the sintering window (W) compared to that of pure nylon-6 (comparative example C7) is achieved (example I13).

Blends of Nylon-6 with Nylon-6I/6T

For production of blends of nylon-6 with nylon-6I/6T, the components specified in table 8 were compounded in the ratios specified in table 8 in a DSM 15 cm³ miniextruder (DSM-Micro15 microcompounder) at a speed of 80 rpm (revolutions per minute) at 260° C. for a mixing time of 3 min (minutes) and then extruded. The extrudates obtained were then ground in a mill and sieved to a particle size of <200 μm.

The blends obtained were characterized as described above. The results are shown in table 9.

TABLE 8

| | (P1a) | (P1b) | (P1c) | (AP6) | (AP7) | (AP8) |
|---|---|---|---|---|---|---|
| Example | [% by wt.] | [% by wt.] | [% by wt.] | [% by wt.] | [% by wt.] | [% by wt.] |
| Polyamide | PA 6 | PA 6 | PA 6 | PA 6I6T | PA 6I6T | PA 6I6T |
| C14 | 100 | | | | | |
| I15 | 79 | | | 21 | | |
| I16 | | 79 | | 21 | | |
| I17 | | | 79 | 21 | | |
| I18 | 79 | | | | 21 | |
| I19 | 79 | | | | | 21 |

TABLE 9

| | Magnitude | | | | | |
|---|---|---|---|---|---|---|
| | of complex | | | | Broadening | |
| | viscosity | | | | of sintering | |
| | at 0.5 rad/s, | | | Sintering | window | |
| Exam- | 240° C. | T_{M} | T_{C} | window W | compared to | T_{G} |
| ple | [Pas] | [° C.] | [° C.] | [K] | (P1a) | [° C.] |
| C14 | 370 | 219.7 | 187.8 | 16.7 | — | 53 |
| I15 | 463 | 219.5 | 173.2 | 24.5 | 7.8 | 68 |
| I16 | 251 | 219.4 | 173.3 | 24.6 | 7.9 | 66 |
| I17 | 142 | 219.5 | 173.4 | 24.4 | 7.7 | 66 |
| I18 | 641 | 218.5 | 176.5 | 27.6 | 10.9 | 66 |
| I19 | 670 | 218.5 | 176.4 | 24.5 | 7.8 | 67 |

AD the PA 6T6Ts used bring about significant broadening of the sintering window and a distinct increase in the glass transition temperature (T_{G}) of the sinter powder (SP). These effects are independent of the PA 6 base polymer used.

Comparison of PA 6-PA 6I6T Blends with PA 6/6I6T Copolymers

For production of blends of nylon-6 with nylon-6I/6T, the components specified in table 10 were compounded in the ratios specified in table 10 in a DSM 15 cm³ miniextruder (DSM-Micro15 microcompounder) at a speed of 80 rpm (revolutions per minute) at 260° C. for a mixing time of 3 min (minutes) and then extruded. The extrudates obtained were then ground in a mill and sieved to a particle size of <200 μm.

The blends obtained and the copolyamides (P5), (P8), (P9) and (P10) were characterized as described above. To determine the thermooxidative stability of the blends, the complex shear viscosity of freshly produced blends and of blends after oven aging at 0.5% oxygen and 195° C. for 16 hours was determined. The ratio of viscosity after storage (after aging) to the viscosity before storage (before aging) was determined. The viscosity is measured by means of rotary rheology at a measurement frequency of 0.5 rad/s at a temperature of 240° C.

The results are shown in table 11.

TABLE 10

| | (P1a) | (P5) | (AP6) | (P8) | (P9) | (P10) |
|---|---|---|---|---|---|---|
| Example | [% by wt.] | [% by wt.] | [% by wt.] | [% by wt.] | [% by wt.] | [% by wt.] |
| Polyamide | PA6 | PA 6/6I6T | PA 6I6T | PA 6/6I6T | PA 6/6I6T | PA 6/6I6T |
| C24 | 100 | | | | | |
| I25 | 79 | | 21 | | | |
| C20 | | 100 | | | | |
| C21 | | | | 100 | | |
| C22 | | | | | 100 | |
| C23 | | | | | | 100 |

TABLE 11

| | Magnitude | | | | | |
|---|---|---|---|---|---|---|
| | of complex | Ratio of | | | | |
| | viscosity | viscosity | | | | |
| | at 0.5 rad/s, | after aging | | | Sintering | |
| | 240° C. | to before | T_{M} | T_{C} | window W | T_{G} |
| Example | [Pas] | aging | [° C.] | [° C.] | [K] | [° C.] |
| C24 | 370 | 0.11 | 219.7 | 187.8 | 16.7 | 53 |
| I25 | 463 | 0.25 | 219.5 | 173.2 | 24.5 | 66 |
| C20 | 3050 | 0.54 | 175.6 | 121 | 43.7 | 59 |
| C21 | — | — | 187.1 | 126.8 | 19 | 61 |
| C22 | — | — | 201.4 | 149.4 | 19 | 60 |
| C23 | — | — | 209.3 | 166.4 | 13 | 57 |

It is clearly apparent that the copolymer from example C20, in spite of identical molar composition to the blend of inventive example 125, has a distinctly lower melting temperature. In addition, the viscosity of the copolymer is distinctly increased. The sintering window of copolymer C20 is much broader than that of the blend of example 125. However, copolymer C20 has a distinctly lower melting temperature compared to PA 6, and so the properties of copolymer C20 overall are distinctly different than those of the components (A) that are preferred in accordance with the invention (especially of PA 6). Copolymer C20 is therefore unsuitable for production of shaped bodies by means of selective laser sintering.

Sintering Powder (SP) for Selective Laser Sintering

For production of the sinter powder (SP), the components specified in table 12 were compounded in the ratio specified in table 12 in a twin-screw extruder (MC26) at a speed of 300 rpm (revolutions per minute) and a throughput of 10 kg/h at a temperature of 270° C. with subsequent strand pelletization.

The pelletized material thus obtained was ground to a particle size of 10 to 100 μm.

The properties of the sinter powder (SP) obtained were determined as described above. The results can be seen in table 13.

TABLE 12

| | (P1a) | (P2) | (P3) | (P4) | (AP6) | (AP8) | (A1) |
|---|---|---|---|---|---|---|---|
| Example | [% by wt.] | [% by wt.] | [% by wt.] | [% by wt.] | [% by wt.] | [% by wt.] | [% by wt.] |
| Polyamide | PA 6 | PA 6, 10 | PA 66/6 | PA 66 | PA 6I6T | — | |
| C24 | 100 | | | | | | |
| I26 | 89 | | | | 11 | | |
| I27 | 84 | | | | 16 | | |
| I28 | 79 | | | | 21 | | |
| I29 | 78.5 | | | | 21 | | 0.5 |
| C30 | | 100 | | | | | |
| I31 | | 78.5 | | | 21 | | 0.5 |
| C32 | | | 100 | | | | |
| I33 | | | 78.5 | | 21 | | 0.5 |
| C34 | | | | 100 | | | |
| I35 | | | | 78.5 | 21 | | 0.5 |
| I45 | 78.6 | | | | 21 | | 0.4 |
| I46 | 84.6 | | | | 15 | | 0.4 |
| I47 | 78.6 | | | | | 21 | 0.4 |

TABLE 13

| | Magnitude | | | | | | | |
|---|---|---|---|---|---|---|---|---|
| | of complex | Ratio of | | | | | | Broadening |
| | viscosity | viscosity | | | | Sintering | Broadening | of sintering |
| | at 0.5 rad/s, | after aging | | | Sintering | window after | of sintering | window ΔW |
| | 240° C. | to before | T_{M} | T_{C} | window W | aging W | window ΔW | [K] after |
| Example | [Pas] | aging | [° C.] | [° C.] | [K] | [K] | [K] | aging |
| C24 | 370 | 0.11 | 219.7 | 187.8 | 16.7 | 11.2 | — | — |
| I26 | 577 | 0.17 | 219.6 | 180.4 | 22.0 | n.d. | 5.3 | — |
| I27 | 641 | 0.17 | 218.6 | 177.3 | 24.3 | n.d. | 7.6 | — |
| I28 | 637 | 0.25 | 217.9 | 173.4 | 24.1 | 23.9 | 7.4 | 12.7 |
| I29 | 692 | 2.9 | 217.8 | 170.2 | 28.2 | 26.8 | 11.5 | 15.6 |
| C30 | 464 | 4.4 | 221.3 | 193 | 18.3 | 9.6 | — | — |
| I31 | 813 | 19.9 | 220.1 | 190.4 | 18.7 | 14.1 | 0.4 | 4.5 |
| C32 | 110 | n.d. | 240 | 208 | 9.6 | n.d. | — | — |
| I33 | 290 | 0.64 | 236 | 198 | 16.1 | 15.7 | 6.5 | — |
| C34 | 158 | 8.5 | 262 | 233 | 14.3 | n.d. | — | — |
| I35 | 335 | 0.72 | 258 | 224 | 18.4 | 14.1 | 4.1 | — |
| I45 | 632 | 3.4 | 218.2 | 172.5 | 28.3 | 27.1 | 11.6 | 15.9 |
| I46 | 616 | 1.9 | 218.2 | 178.4 | 22.4 | 22.8 | 5.7 | 11.6 |
| I47 | 682 | 2.5 | 217.9 | 177.7 | 24.0 | n.d. | 7.3 | n.d. |

It is clearly apparent that the sinter powder (SP) of the invention has a distinctly broadened sintering window, even after thermooxidative storage (aging). The sinter powder (SP) of the invention also exhibits lesser degradation of the molecular weight after aging, expressed as the viscosity ratio.

Laser Sintering Experiments

The sinter powder (SP) was introduced with a layer thickness of 0.12 mm into the cavity at the temperature specified in table 14. The sinter powder (SP) was subsequently exposed to a laser with the laser power output specified in table 14 and the point spacing specified, with a speed of the laser over the sample during exposure of 5 m/s. The point spacing is also known as laser spacing or lane spacing. Selective laser sintering typically involves scanning in stripes. The point spacing gives the distance between the centers of the stripes, i.e. between the two centers of the laser beam for two stripes.

TABLE 14

| | | Laser power | | |
|---|---|---|---|---|
| | Temperature | output | Laser speed | Point spacing |
| Example | [° C.] | [W] | [m/s] | [mm] |
| C24 | 209 | 18 | 5 | 0.2 |
| I27 | 195 | 20/25 | 5 | 0.2 |
| I28 | 195 | 20 | 5 | 0.2 |
| I29 | 200 | 20/25/30 | 5 | 0.2 |
| C30 | 200 | 20/25 | 5 | 0.2 |
| I31 | 195 | 20/25 | 5 | 0.2 |
| C32 | 215 | 25 | 5 | 0.2 |
| I33 | 215 | 20/25 | 5 | 0.2 |
| C34 | 240 | 25 | 5 | 0.2 |
| I35 | 240 | 20/25 | 5 | 0.2 |
| I45 | 198 | 25 | 5 | 0.2 |
| I46 | 198 | 25 | 5 | 0.2 |
| I47 | 198 | 25 | 5 | 0.2 |

Subsequently, the properties of the tensile bars (sinter bars) obtained were determined. The results are shown in table 15.

The warpage of the sinter bars obtained was determined by placing the sinter bar with the concave side down onto a planar surface_{—} The distance (aₘ) between the planar surface and the upper edge of the middle of the sinter bar was then determined. In addition, the thickness (dₘ) in the middle of the sinter bar was determined. Warpage in % is then determined by the following formula:

W=100*(aₘ−dₘ)/dₘ

The dimensions of the sinter bars were typically length 80 mm, width 10 mm and thickness 4 mm.

The flexural strength corresponds to the maximum stress in the bending test. The bending test is a three-point bending test according to EN ISO 178:2010 +A1:2013.

Processibility was assessed qualitatively with “2” meaning “good”, i.e. low warpage of the component, and “5” meaning “inadequate”, i.e. severe warpage of the component.

Surface roughness is reported as mean roughness Ra and as averaged roughness depth Rz.

The mean roughness Ra indicates the mean distance of a measurement point on the surface from a center line. This center line intersects the true profile of the surface within the reference zone in such a way that the sum total of the profile deviations based on the center line is minimized. The mean roughness Ra thus corresponds to the arithmetic mean of the magnitude of the deviation from the center line.

The averaged roughness depth Rz is ascertained as follows: A defined measurement zone on the surface of the workpiece is divided into seven individual measurement zones, the middle five measurement zones being of the same size. Evaluation is effected only over these five measurement zones. For each of these individual measurement zones of the profile, the difference between the maximum and minimum value is ascertained (individual roughness depth), then the five individual roughness depths obtained in this way are used to form the mean, the averaged roughness depth Rz.

TABLE 15

| | Warpage of | | | | |
|---|---|---|---|---|---|
| | flexural bar | | Processibility | Flexural | Surface |
| | from SLS | Warpage | in SLS | strength | roughness |
| Example | [%] | [grade] | [grade] | [MPa] | [μm] |
| C24 | 50 ± 5 | 4 | 4 | n.d. | n.d. |
| I27 | 21 ± 9/22 ± 5 | 2 | 3 | 108.5 | n.d. |
| I28 | n.d. | n.d. | 2 | n.d. | Ra: 12 |
| | | | | | Rz: 35 |
| I29 | 35 ± 9/52 ± 14/ | 3 | 2 | 100 | Ra: 9 |
| | 42 ± 14 | | | | Rz: 27 |
| C30 | 21 ± 9/13 ± 4 | 2 | 3-4 | 73.5 | Ra: 16 |
| | | | | | Rz: 44 |
| I31 | 23 ± 4/28 ± 9 | 2 | 3 | 101 | Ra: 13 |
| | | | | | Rz: 36 |
| C32 | | 5 | 5 | | |
| | | | (excessive | | |
| | | | warpage | | |
| | | | during | | |
| | | | construction) | | |
| I33 | 43 ± 12/33 ± 9 | 3 | 3 | 74 | Ra: 7 |
| | | | | | Rz: 19 |
| C34 | | 5 | 5 | | |
| | | | (excessive | | |
| | | | warpage | | |
| | | | during | | |
| | | | construction) | | |
| I35 | 21 ± 4/14± 5 | 2 | 2 | 35 | Ra: 13 |
| | | | | | Rz: 37 |

For the tensile bars (sinter bars) from examples 145 to 147, in addition, the tensile strength, tensile modulus of elasticity and elongation at break were determined according to ISO 527-1: 2012 in the dry state after drying at 80° C. for 336 hours under reduced pressure. The grades for warpage and processibility were determined as above.

TABLE 15a

| | | | Tensile | Tensile | Elongation |
|---|---|---|---|---|---|
| | Warpage | Processibility | modulus | strength | at break |
| Example | grade | in SLS | [MPa] | [MPa] | [%] |
| I45 | 2 | 2 | 3660 | 56.7 | 1.7 |
| I46 | 3 | 2 | 3696 | 57.2 | 1.7 |
| I47 | 3 | 2 | 3432 | 71.7 | 2.4 |

It is apparent that the shaped bodies produced from the sinter powders (SP) of the invention have distinctly lower warpage and better processibility, higher strength and lower surface roughness.

The shaped bodies produced from the sinter powders (SP) of the invention additionally have a very good tensile modulus and good tensile strength. Their elongation at break is also within a range suitable for application thereof.

Blend of PA 6T/6 and PA 6I/6T, of PA6/6,6 and PA 6I/6T and of PA 12 and PA 6I/6T

For production of blends of nylon-6T/6 with PA 6I/6T and of PA 12 with PA 6I/6T, the components specified in table 16 were compounded in the ratios specified in table 16 in a DSM 15 cm³ miniextruder (DSM-Microl 5 microcompounder) at a speed of 80 rpm (revolutions per minute) at 260° C. for a mixing time of 3 min (minutes) and then extruded. The extrudates obtained were then ground in a mill and sieved to a particle size of <200 μm.

Examples C36 and C39 were not compounded and extruded, but processed directly as obtained from the manufacturer.

The blends obtained were characterized as described above. The results can be seen in table 17.

TABLE 16

| | (P11) | (P12) | (P13) | (AP6) | |
|---|---|---|---|---|---|
| Example | [% by wt.] | [% by wt.] | [% by wt.] | [% by wt.] | Processing |
| Polyamide | PA 12 | PA 6T/6 | PA 6/66 | PA 6I/6T | |
| C36 | 100 | | | | not |
| | | | | | processed |
| C37 | 100 | | | | extruded |
| C38 | 79 | | | 21 | extruded |
| C39 | | 100 | | | not |
| | | | | | processed |
| C40 | | 100 | | | extruded |
| I41 | | 79 | | 21 | extruded |
| C42 | | | 100 | | extruded |
| I43 | | | 90 | 10 | extruded |
| I44 | | | 79 | 21 | extruded |

TABLE 17

| | | | | Sintering window |
|---|---|---|---|---|
| Example | T_{G} [° C.] | T_{M} [° C.] | T_{C} [° C.] | W [K] |
| C36 | 37 | 177.2 | 130.3 | |
| C37 | 37 | 177.8 | 152.4 | 17.4 |
| C38 | 36 | 177.2 | 152.3 | 17.3 |
| C39 | 105 | 291.1 | 241.1 | n.d |
| C40 | 104 | 294.2 | 253.2 | 8.6 |
| I41 | 109 | 286.9 | 231.5 | n.d. |
| C42 | 52 | 195.5 | 159.2 | 20.6 |
| I43 | 56 | 194.4 | 153.2 | 24.6 |
| I44 | 63 | 193.3 | 141.0 | 32.5 |

In the blend of PA 12 with PA 6I/6T (comparative example C38), the crystallization temperature (T_{C}) of the blend remains the same compared to the crystallization temperature (T_{C}) of pure PA 12 (comparative example C37); there is likewise no change in the melting temperature (T_{M}). Thus, PA 6I/6T does not lead to broadening of the sintering window.

By contrast, the crystallization temperature (T_{C}) of the blend of PA 6T/6 with PA 6I/6T (example 141) is well below the crystallization temperature (T_{C}) of pure PA 6T/6. At the same time, the melting temperature (T_{M}) is slightly lowered compared to the melting temperature (T_{M}) of pure PA 6T/6, but the lowering of the melting temperature (T_{M}) is smaller than the lowering of the crystallization temperature (T_{C}), and so broadening of the sintering window is achieved overall.

In a blend of PA 6/6,6 with PA 6I/6T, lowering of the crystallization temperature (T_{c}) is likewise observed. The melting temperature (T_{M}) likewise falls slightly compared to pure PA 6/6,6, but less significantly than the crystallization temperature (T_{c}), such that a distinctly broadened sintering window is achieved overall.

1-11. (canceled)

12. A process for producing a shaped body by selective laser sintering of a sinter powder (SP), wherein the sinter powder (SP) comprises the following components:
(A) at least one semicrystalline polyamide comprising at least one unit selected from the group consisting of —NH—(CH₂)ₘ—NH— units where m is 4, 5, 6, 7 or 8,
—CO—(CH₂)ₙ—NH— units where n is 3, 4, 5, 6 or 7, and
—CO—(CH₂)ₒ—CO— units where o is 2, 3, 4, 5 or 6,
(B) at least one nylon-6I/6T,
wherein the sinter powder (SP) comprises in the range from 75% to 90% by weight of component (A) and in the range from 10% to 25% by weight of component (B), based in each case on the sum total of the percentages by weight of components (A) and (B).

13. The process according to claim 12, wherein the sinter powder (SP) additionally comprises at least one additive selected from the group consisting of phenols, carbon black, inorganic black dyes and organic black dyes.

14. The process according to claim 12, wherein the sinter powder (SP) comprises in the range from 75% to 85% by weight of component (A) and in the range from 15% to 25% by weight of component (B), based in each case on the sum total of the percentages by weight of components (A) and (B).

15. The process according to claim 12, wherein the sinter powder (SP) has
a D10 in the range from 10 to 30 μm,
a D50 in the range from 25 to 70 μm and
a D90 in the range from 50 to 150 μm.

16. The process according to claim 12, wherein the sinter powder (SP) has a melting temperature (T_{M}) in the range from 180 to 270° C.

17. The process according to claim 12, wherein the sinter powder (SP) has a crystallization temperature (T_{C}) in the range from 120 to 190° C.

18. The process according to claim 12, wherein the sinter powder (SP) has a sintering window (W_{SP}), where the sintering window (W_{SP}) is the difference between the onset temperature of melting (T_{M}^{onset}) and the onset temperature of crystallization (T_{C}^{onset}) and where the sintering window (W_{SP}) is in the range from 15 to 40 K.

19. The process according to claim 12, wherein the sinter powder (SP) is produced by grinding components (A) and (B) at a temperature in the range from −210 to −195° C.

20. The process according to claim 12, wherein component (A) is selected from the group consisting of PA 6, PA 6,6, PA 6,10, PA 6,12, PA 6,36, PA 6/6,6, PA 6/6I6T, PA 6/6T and PA 6/6I.

21. A shaped body obtainable by the process according to claim 12.

22. A process for broadening the sintering window (W_{SP}) of a sinter powder (SP) compared to the sintering window (W_{A}) of component (A), which comprises utilizing a nylon-6I/6T in the sinter powder (SP) comprising the following components:
(A) at least one semicrystalline polyamide comprising at least one unit selected from the group consisting of —NH—(CH₂)ₘ—NH— units where m is 4, 5, 6, 7 or 8, —CO—(CH₂)ₙ—NH— units where n is 3, 4, 5, 6 or 7, and —CO—(CH₂)ₒ—CO— units where o is 2, 3, 4, 5 or 6,
(B) at least one nylon-6I/6T
where the sintering window (W_{SP}; W_{A}) in each case is the difference between the onset temperature of melting (T_{M}^{onset}) and the onset temperature of crystallization (T_{C}^{onset}).
